(19) United States
(12) Patent Application Publication
(10) Pub. No.: US 2005/0178451 A1
(43) Pub. Date: Aug. 18, 2005

(54) Solenoid valve

(75) Inventor: Madoka Inami, Kariya-shi (JP)

Correspondence Address: REED SMITH LLP;Suite 1400, 3110 Fairview Park Drive, Falls Church, VA, 22042, US

(73) Assignee: Aisin Seiki Kabushiki Kaisha

(21) Appl. No.: 11/057,222

(22) Filed: Feb. 15, 2005

(30) Foreign Application Priority Data
Feb. 18, 2004 (JP) 2004-041990

(51) Int. Cl. F15B 13/044

(52) U.S. Cl. 137/625.65

(57) ABSTRACT

A solenoid valve comprises a sleeve having ports and through hole, a spool slidably located in the through hole of the sleeve so that an intercommunication between the ports are changed, one end of the spool being faced with outside of the sleeve, a solenoid means for driving the spool, a case fixed to the sleeve to form an inner space for accommodating the solenoid means, and a diaphragm for sealing the inner space from the through hole, wherein a passage is formed in the spool so that the inner space is fluidlically communicated with an outside of the sleeve.

### CROSS REFERENCE TO RELATED APPLICATIONS

This application is based on and claims priority under 35 U.S.C. §119 with respect to Japanese Patent Application No. 2004-041990 filed on Feb. 18, 2004, the entire content of which is incorporated herein by reference.

### FIELD OF THE INVENTION

The present invention relates to a solenoid valve for switching passages of a hydraulic circuit.

### BACKGROUND

The solenoid valve comprises a cylindrical yoke, a coil wound on the yoke, a plunger located in the yoke to be movable in axial direction thereof, and a valve member to be moved in cooperation of the movement of the yoke. The solenoid valve controls fluid flow (oil flow) and possible foreign particles in the fluid enter a gap between the yoke and the plunger.

According to a solenoid valve described in JP2000-39083A, a clearance is provided to allow the foreign particles pass therethrough. It is not possible to make the clearance small so as to prevent the foreign particles from stopping at the clearance. In order to make the solenoid valve small as possible, a space for accommodating the yoke and the plunger is constructed so that the foreign particles are hard to enter the space. If the space is sealed, the plunger is prevented from smooth movement since the plunger must be moved in the sealed space.

According to a solenoid valve described in JP2003-329164A, a passage is provided so as to fluidlically communicate the space with outside of the space. The passage is able to be so-called labyrinth passage to prevent the foreign particles from entering the space through the passage.

The labyrinth passage is provided in a case for accommodating the coil, but the case is complicatedly processed. The case is suitably manufactured by press forming of a metal plate due to cost reduction.

### SUMMARY OF THE INVENTION

In light of the foregoing, the present invention provides a solenoid valve comprising a sleeve having ports and through hole, a spool slidably located in the through hole of the sleeve so that an intercommunication between the ports are changed, one end of the spool being faced with outside of the sleeve, a solenoid means for driving the spool, a case fixed to the sleeve to form an inner space for accommodating the solenoid means, and a diaphragm for sealing the inner space from the through hole, wherein a passage is formed in the spool so that the inner space is fluidlically communicated with an outside of the sleeve.

### BRIEF DESCRIPTION OF THE DRAWINGS

The foregoing and additional features and characteristics of the present invention will become more apparent from the following detailed description when considered with reference to the accompanying drawings, wherein:

FIG. 1 is a cross-sectional view of a solenoid valve according to the invention; and

FIG. 2 is a cross-sectional view of a spool valve of the solenoid valve.

### DETAILED DESCRIPTION

Embodiments of the present invention will be explained with reference to illustrations of the drawing figures as follows.

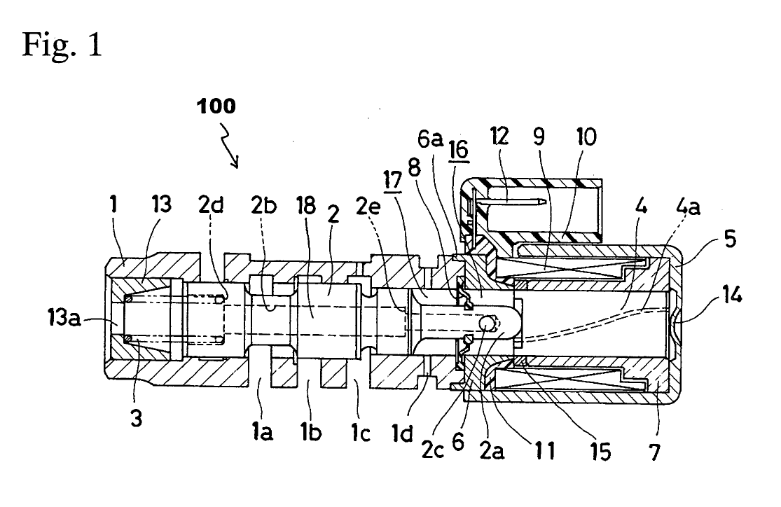

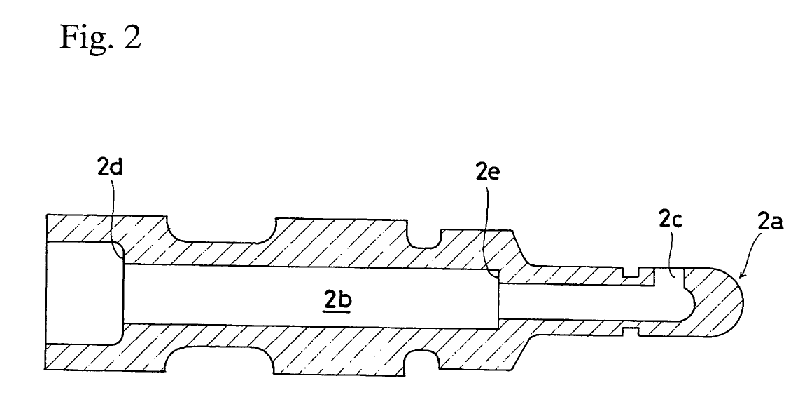

As shown in FIGS. 1 and 2, a solenoid valve 100 comprises a cylindrical sleeve 1 and a cup-shaped case 5 located at one end of the sleeve 1. The sleeve with ports 1a through 1c and passage 1d. The number of the ports is not restricted in three. A spool 2 is located in the sleeve 1 so as to be slidably movable in axial direction thereof. A valve stopper 13 is inserted into the open end (left end) of the sleeve 1 to limit the movement of the spool 2 in leftward direction. A spring 3 is located between the spool 2 and the stopper 13 so as to urge the spool 2 in rightward direction. An opening 13a is formed to fluidlically communicate inside of the sleeve with outside thereof.

A bobbin 11 is located in the case 5 and a coil 9 is wound around the bobbin 11. A first yoke 6 and a second yoke 7 are coaxially located inside and each sides of the bobbin 11, respectively. The yokes 6 and 7 are made of magnetic material. A spacer 15 made of non-magnetic material (eg. aluminum) is coaxially located between the yokes 6 and 7. A column-shaped plunger 4 made of magnetic material is movably located in the yokes 6 and 7 as well as the spacer 15 in axial direction of the yokes 6 and 7. A left end of the plunger 4 is located within the spacer 15 when the plunger 4 is located to be contacted with a stopper 14 that is integrally formed with the case 5. The left end of the plunger 4 is contacted with a right end 2a of the spool 2. Namely, the spool 2 and the plunger 4 are restricted by the stopper 14 in such manner that a left end of the plunger 4 is contacted with the stopper 14. A spiral passage 4a is formed outer surface of the plunger 4 so as to fluidlically communicate both sides thereof. The second yoke 7 is inserted into the case 5 to be fixed each other.

A connector 10 having terminals 12 is fixed to the bobbin 11. Both ends of the coil 9 are electrically connected to the terminals 12. When the coil 9 is energized through the terminal 12, the coil 9 generates a magnetic field in cooperation with the yokes 6 and 7. A solenoid means comprises the plunger 4, the case 5, the yokes 6 and 7, the coil 9 as well as the bobbin 11.

An inner circumference of a diaphragm 8 is fixed to a circumferential groove of the spool 2 at the rightward portion thereof. An outer circumference of the diaphragm 8 is fixed between the right end of the sleeve 1 and the left end of the yoke 6. The outer circumference is able to be fixed another portion of the sleeve 1 and/or yoke 6. The diaphragm 8 seals an inner space 16 of case 5 from another inner space (through hole) 17. The second inner space 16 is formed by the first yoke 6, plunger 4 and the diaphragm 8 while the inner space 17 is formed by the sleeve 1, the spool 2 and the diaphragm 8. A flange 6a of the first yoke 6 is projected from the left end of the first yoke 6 to the sleeve 1 so that the right end of the sleeve 1 and the flange 6a are overlapped each other and welded by laser.

An axial hole 2b and a radial hole 2c are provided in the spool 2. The hole 2b is elongated in the sleeve in axial direction thereof. The hole 2c intersects the hole 2b to fluildlically communicate each other. Namely, a L-shaped passage is comprised by the holes 2b and 2c. The passage 18 fulidlically communicates the left end of the spool 2 and the second inner space 16. The hole 2b is provided with steps 2d and 2e so that the inner diameter of the hole 2b gradually becomes narrower in rightward direction. The right end of the spring 3 is supported by the step 2d. The number of the steps is not restricted in two.

When the coil 9 is not energized, the spool 2 and the plunger 4 are urged by the spring 3 in rightward direction. The right end of the plunger 4 is at rest on the stopper 14. The fluid communication between the ports 1a and 1b is established by the spool 2. When the coil 9 is energized, the magnetic flux is generated through the coil 9, the first yoke 6, plunger 4 and the second yoke 7 so that the plunger 4 is urged in leftward direction. The spool 2 and the plunger 4 are uniformly urged against the spring 3 in leftward direction. The fluid communication between the ports 1a and 1b is terminated by the spool 2. The coil 9 is energized in duty-ratio manner so that the solenoid valve 100 functions as linear solenoid valve. The spool 2 is able to be stopped at an intermediate portion in the sleeve 1. The spool 2 is able to be rapidly moved so that a variable orifice is achieved between the ports 1a and 1b.

The plunger 4 is smoothly moved in axial direction of the solenoid valve 100 since the passage 4a communicates both sides of the plunger 4 as well as the second inner space 16 is communicated with the outside of the solenoid valve 100 through the passage 18 and the hole 13a of the stopper 13. A possible foreign particles in the fluid enter the holes 1a, 1b and 1c, but the diaphragm 8 prevents the foreign particles from entering the second inner space 16.

While the plunger 4 moves in the case 5, fluid flow is established between the second inner space 16 and the outside of the solenoid valve 100 through the passage 18. A possible foreign particles existing around the hole 13a would not enter the second inner space 16 through the passage 18 because of the following reasons. Firstly the length of the passage 18 is sufficiently long against the movement length of the plunger 4 and the secondly the passage 18 is bent at the connecting portion of the holes 2b and 2c. Even if the foreign articles enter the passage 18, the foreign articles stop at the connecting portion. Additionally the step 2e of the passage 18 is useful so that the foreign articles stop thereat.

The case 5 is made by press forming of metal plate. The passage 18 is processed by boring of the spool 2 and the steps 2d and 2e are processed by plural boring. The stopper 14 is uniformly formed as part of the case 5 so that number of parts is able to be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A solenoid valve comprising:
a sleeve having ports and through hole,
a spool slidably located in the through hole of the sleeve so that an intercommunication between the ports are changed, one end of the spool being faced with outside of the sleeve,
a solenoid means for driving the spool,
a case fixed to the sleeve to form an inner space for accommodating the solenoid means, and
a diaphragm for sealing the inner space from the through hole,
wherein a passage is formed in the spool so that the inner space is fluidlically communicated with an outside of the sleeve.

2. The solenoid valve according to the claim 1, wherein the solenoid means comprises a case, a bobbin accommodated in the case, coil wound around the bobbin, a yoke located in the coil and a plunger movably located in the yoke so that the plunger is contacted with the spool spool.

3. The solenoid valve according to the claim 2, wherein an inner circumference of the diaphragm is fixed to the spool and an outer circumference of the diaphragm is fixed to the yoke.

4. The solenoid valve according to the claim 1, wherein the passage comprises an axial hole and a radial hole communicated with the axial hole, the passage being bent at the connecting portion of the holes.

5. The solenoid valve according to the claim 3, wherein the passage comprises an axial hole and a radial hole communicated with the axial hole, the passage being bent at the connecting portion of the holes.

6. The solenoid valve according to the claim 1, wherein the passage becomes narrower by a step from the outside of the sleeve to the inner space.

7. The solenoid valve according to the claim 4, wherein the passage becomes narrower by a step from the outside of the sleeve to the inner space.

8. The solenoid valve according to the claim 5, wherein the passage becomes narrower by a step from the outside of the sleeve to the inner space.

9. The solenoid valve according to the claim 1, wherein the length of the passage is sufficiently long against the movement length of the plunger.

10. The solenoid valve according to the claim 5, wherein the length of the passage is sufficiently long against the movement length of the plunger.

11. The solenoid valve according to the claim 8, wherein the length of the passage is sufficiently long against the movement length of the plunger.

12. The solenoid valve according to the claim 11, wherein another passage is formed outer surface of the plunger so as to fluidlically communicate both sides of the plunger.
